(19) United States
(12) Patent Application Publication
(10) Pub. No.: US 2014/0124327 A1
(43) Pub. Date: May 8, 2014

(54) CLUTCH ASSEMBLY WITH IMPROVED CLUTCH PLATE INTERFACE

(71) Applicants: Value Extraction LLC, Dearborn, MI (US); Szuba Consulting, Inc., Dearborn, MI (US)

(72) Inventor: Joseph Szuba, Dearborn, MI (US)

(73) Assignees: Value Extraction LLC, Dearborn, MI (US); Szuba Consulting, Inc., Dearborn, MI (US)

(21) Appl. No.: 14/074,644

(22) Filed: Nov. 7, 2013

Related U.S. Application Data
(60) Provisional application No. 61/723,483, filed on Nov. 7, 2012.

(51) Int. Cl. F16D 11/00

(52) U.S. Cl. CPC F16D 11/00
USPC 192/108

(57) ABSTRACT

A clutch assembly includes a housing defining an axis. A plurality of plates disposed within the housing are in driving engagement with the housing around the axis. The housing defines a housing wall circumscribing the axis and having a sinusoidal configuration including a wall crest and a wall trough. The wall crest and the wall trough are substantially parallel to the axis defined by the housing. The plates have teeth complimentary of the sinusoidal configuration of the housing wall for engaging the housing wall enabling the driving engagement between the housing wall and the plates.

The present application claims priority to U.S. Provisional Patent Application No. 61/723,483 filed Nov. 7, 2012.

### BACKGROUND

Clutch housings have been used in transmissions for transferring motive force between components of a vehicle for many years. A clutch assembly typically includes a number of clutch plates received by a clutch housing that are disposed in driven engagement with an annular wall of the clutch housing. As is known to those of skill in the art, clutch plates are coated with a frictional material, the compression of which causes the clutch plates disposed within the clutch housing to transfer motive force between a spindle axial aligned with the housing and mated to a clutch hub as is known to those of skill in the art of transmission assembly design and manufacturing. Modern performance requirements have resulted in an increase in the number of clutch assemblies in transmission. Manufacturers are presently attempting to design transmissions for motor vehicles having eight, nine, and even ten clutch assemblies. However, the space allowed in a motor vehicle for these transmissions has not been increased.

One configuration of a known clutch housing wall is generally shown at 10. A prior art wall 12 of the clutch housing at 10 includes splines 14. The splines 14 define a trapezoidal configuration having a limited work surface 16 identified along line 18 of FIG. 1. Due to the limited work surface 16 of the prior art housing, a high number of clutch plates are required to transfer enough force between the axle (not shown) and the housing 10. Therefore, it has been necessary to include a significant number of plates in each clutch housing adding to the axial length of the housing, which has a negative impact upon overall size of modern transmissions. Therefore, it would be desirable to develop a clutch assembly having a reduced number of clutch plates enabling the reduction of the axial length of typical clutch assembly.

### SUMMARY

A clutch assembly includes a housing defining an axis. A plurality of plates disposed within the housing are in driving engagement with the housing around the axis. The housing defines a housing wall circumscribing the axis and having a sinusoidal configuration including a wall crest and a wall trough. The wall crest and the wall trough are substantially parallel to the axis defined by the housing. The plates have teeth complimentary of the sinusoidal configuration of the housing wall for engaging the housing wall enabling the driving engagement between the housing wall and the plates.

The inventive clutch assembly solves the problem of reducing axial length by way of increasing the work surface area between the teeth of the clutch plate and the splines defined by the clutch housing. The increased work surface area allows for the reduction of the number of clutch plates required of present clutch assemblies enabling the reduction of the axial length of the housing. The reduction of the axial length of the housing enables modern transmission design to include an increased number of clutches without increasing packaging space required of the transmission.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 shows a partial cross sectional view of a housing wall of a prior art clutch housing;

FIG. 2 shows a perspective view of the clutch housing of the present invention;

FIG. 3 shows a partial cross sectional view of the housing wall of the present invention;

FIG. 4 shows plan view of the clutch housing of the present invention;

FIG. 5 shows a partial cross sectional view of the clutch assembly of the present invention with a clutch plate engaging a wall of the clutch housing;

FIG. 6 shows a partial cross sectional view of a housing wall of a prior art clutch housing;

FIG. 7 shows an overlay of cross sections of the prior art clutch housing wall and the clutch housing wall of the present invention;

FIG. 8 shows an a cross sectional view of an alternative embodiment of the present invention; and

FIG. 9 shows a perspective view of further embodiment of the present invention.

### DETAILED DESCRIPTION

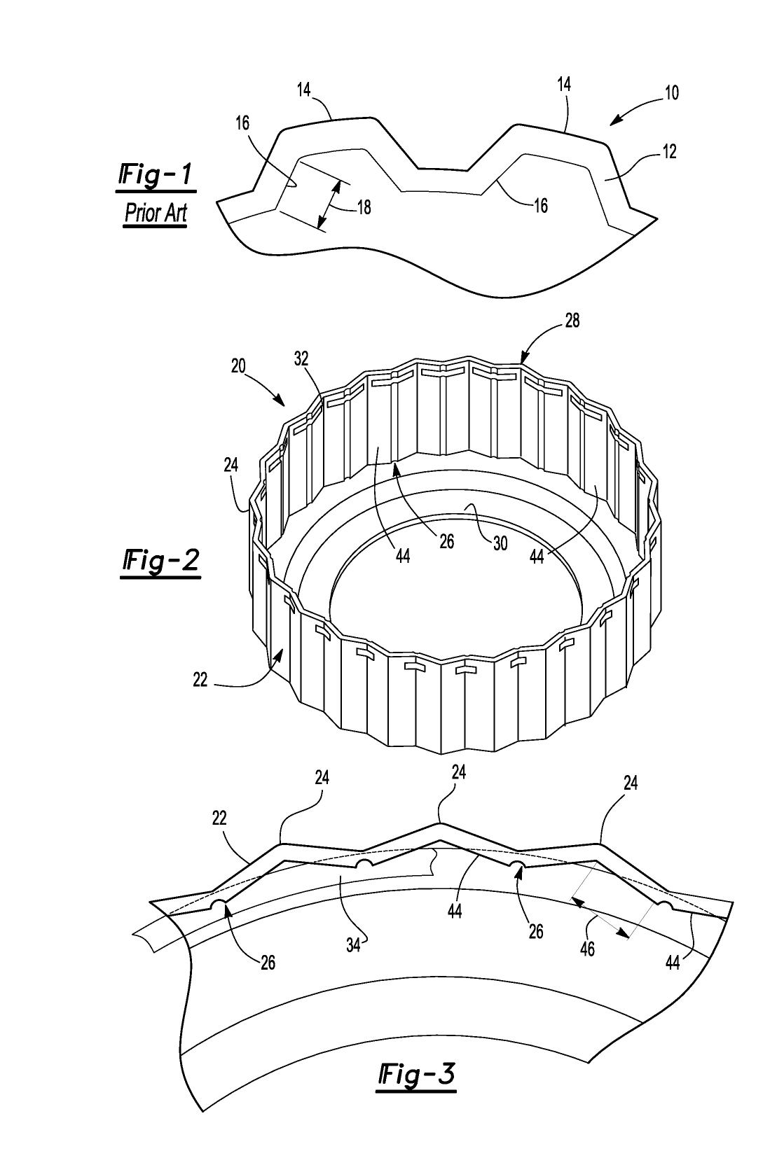

Referring to FIG. 2, a perspective view of an inventive clutch housing is generally shown at 20. The clutch housing 20 defines an axis a (shown in FIG. 3) around which a housing wall 22 is disposed. The housing wall 22 takes a sinusoidal configuration and includes a wall crest 24 and a wall trough 26. The housing 20 defines a distal end 28 and a floor 30 disposed at an opposite end of the housing wall 22 from the distal end 28.

A groove 32 is disposed in the housing wall 22 proximate the distal end 28. The groove 32 retains a snap ring 34 used to retain a plurality of clutch plates 36 (FIG. 5). Each clutch plate 36 defines a plurality of teeth 38 having a sinusoidal configuration that is complementary to the sinusoidal configuration of the housing wall 22. Therefore, the teeth 38 disposed on each clutch plate 36 is disposed in driving engagement with the housing wall 22. As such, the teeth 38 of the plates 36 defined at teeth crests 40 and teeth troughs 42. The teeth crests 40 engage the wall troughs 26 and the wall crest 24 engage the teeth troughs 42. Each clutch plate 36 includes frictional material 37 covering substantially its full contact surface. Therefore, the frictional material 37 covers substantially the full extent of its teeth 38.

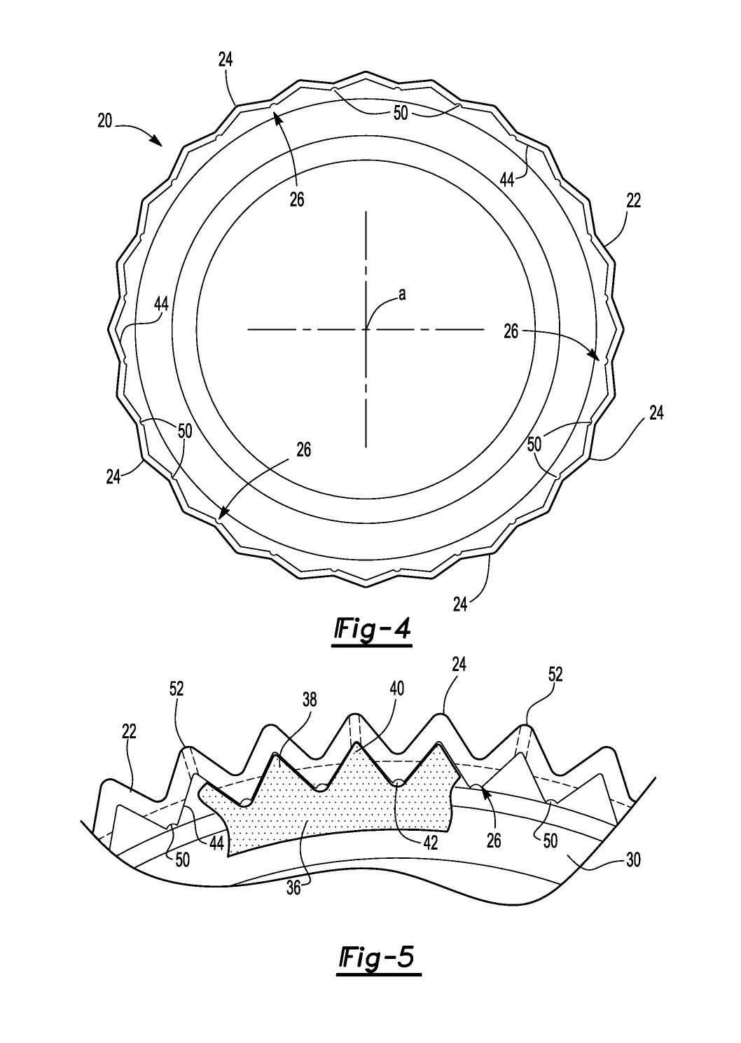

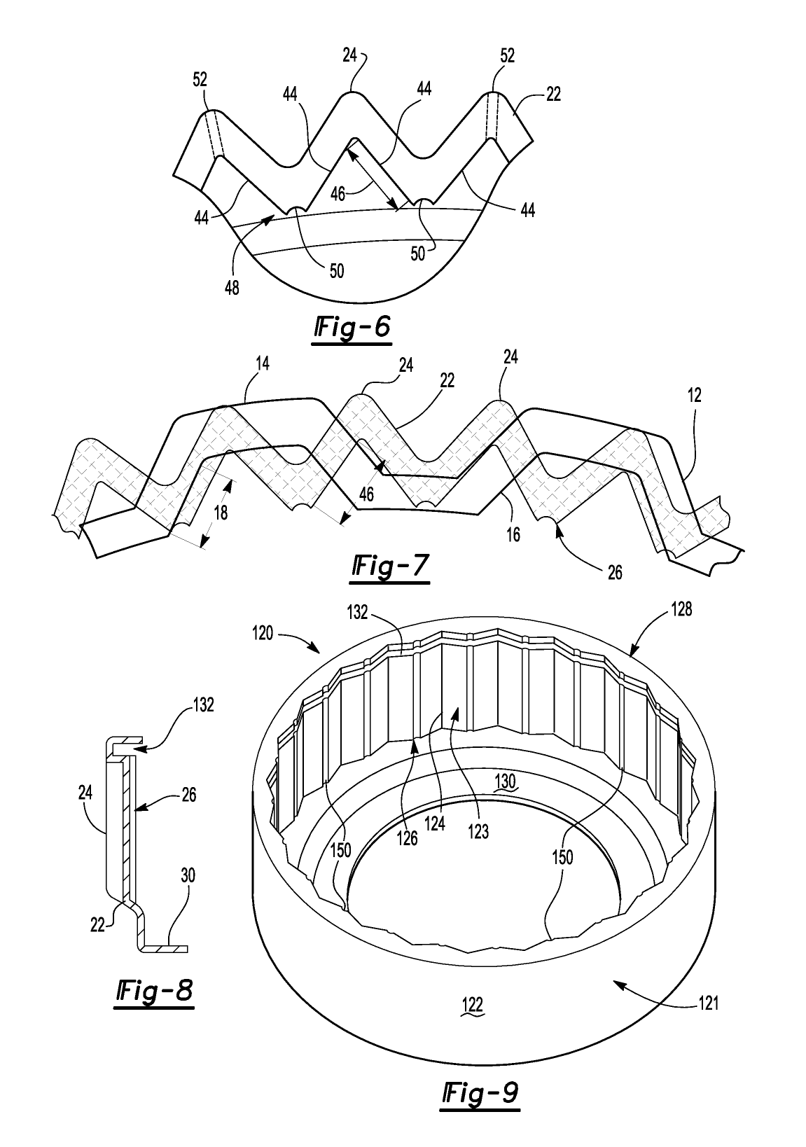

Referring now to FIG. 6, a work surface of the housing wall 22 is clearly is clearly shown at 44. The work surface 44 is defined between the wall crest 24 and the wall trough 26. The work surface 44 engages the teeth 38 of the clutch plates 36 to transfer motive force between the clutch plates 36 and the housing 20. The work surface 44 defines a length 46 that is significantly longer than the prior art length 18 (FIG. 4) of the prior art work surface 16 due to the truncation of the prior art spline 14 setting forth a trapezoidal cross section. In one embodiment, the work surface 44 of the housing wall 22 includes a thirty degree from a line extending radially outwardly from the axis a defined by the housing wall 22. Additionally, the angle of the work surface 44 is contemplated by the inventor to fall within forty five and twenty degrees from the radial line set forth above.

The configuration of the housing wall 22 and the teeth 38 provide benefits best represented by reviewing FIG. 7. As set forth above, the length of work surface 44 of the inventive housing wall shown at 22 is represented by line 46 in FIG. 6. The prior art wall 12 is overlaid upon the present inventive wall 22 showing a work surface having a length 18. It should be obvious to those of ordinary skill in the art that a work surface Y of the present inventive housing wall 22 provides a greater surface area than the prior art work surface X of the prior art wall 12. The greater work surface area allows for the decrease of the number of clutch plates 36 required to transfer force between the various components of the transmission. Additionally, nearly two wall crests 24 of the inventive housing wall 22 is provided in the same circumferential area as the tetrahedral spline 14 of the prior art wall 12. This increase in the number of work surfaces 14 defined by the wall crest 24 and wall trough 26 of the present inventive housing wall 22 allowing for the further decrease in the number of clutch plates 36 required to transfer requisite force between components of the transmission assembly. Additionally, the sinusoidal wall 22 of the present invention is stronger than the prior art wall allowing for a decrease in wall 22 thickness. Maintaining constant out diameter of the housing 20 allows for an increase in the size of the plates 36. Additionally, it is contemplated by the inventor that the housing wall 22 is merely a sleeve received either on the internal surface or the external surface of the housing 20 for providing additional strength to the housing 20. This is particularly advantageous when the housing 20 is made from aluminum and the sleeve can provide a hardened surface based upon material selection.

Referring again to FIG. 6, an inner surface 48 of each wall trough 26 defines a circulation element 50 to provide a venue for lubricant circulating through the housing 20. Additionally, a plurality of apertures 52 are defined by the housing wall 22 to allow lubricant to pass inwardly and outwardly of the housing 20 in a desired manner.

A cross sectional view of an alternative snap ring groove 132 of the housing 20 is shown in FIGS. 8. The housing 20 includes splines defined by wall crest 24 and wall trough 26 that are spaced from the distal end 28 of the housing wall 22. The snap ring groove 312 is formed by forming a flange in the distal end 28 of the housing wall 22. The snap ring is disclosed in U.S. Pat. No. 8,240,446, the contents of which are incorporated herein by reference.

An alternative housing is shown in FIG. 9 at 120, wherein like elements of the prior embodiment include the same numbers only in the 100 series. In this embodiment, the housing 120 includes a substantially smooth outer surface 121 of the housing wall 122. In this embodiment, the sinusoidal surface 123 of the inventive housing wall 122 is disposed only where driving engagement is required with the teeth 38 of the clutch plates 36 as shown in FIG. 5. Therefore, the wall crest 124 and the wall trough 126 are disposed solely upon the inner surface 123 of the housing wall 122. The housing 120 defines a distal end 128 and a floor 130 disposed upon at an opposite end of the housing wall 122 from the distal end 128. The snap ring groove is formed in the housing wall 122 proximate the distal end 128 of the housing wall 122. The circulation element 150 is disposed at the wall trough 126 to facilitate the circulation of lubricant through the housing 120. It is contemplated by the inventor that his embodiment of the housing 120 is formed by either by casting or roll forming sheet metal. However, other methods or combinations of methods of forming the housing 120 are also contemplated, such as, for example, forming the housing 120 from a tube.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation while material to the teachings of the invention without departing from the essential scope thereof. Therefore, it is intended that the invention not be limited to the particular embodiment disclosed as the best mode contemplated for carrying out this invention but that the invention will include all embodiments falling within the scope of the appended claims.

What is claimed is:

1. A clutch assembly, comprising:
a housing defining an axis;
a plurality of plates disposed within said housing and being in driving engagement with said housing around said axis;
said housing defining a housing wall circumscribing said axis and having a sinusoidal configuration including a wall crest and a wall trough, said wall crest and said wall trough being substantially parallel to said axis defined by said housing; and
said plates having teeth complimentary of said sinusoidal configuration for engaging said housing wall enabling driving engagement between said housing wall and said plates.

2. The assembly set forth in claim 1, wherein said teeth of said plates define a teeth crest and a teeth trough with said teeth crest being received by said wall trough and said wall crest being received by said teeth trough.

3. The assembly set forth in claim 1, wherein one of said wall crest and said wall trough define an apex.

4. The assembly set forth in claim 1, wherein said wall trough defines a circulation element providing a venue for lubricant circulating through said assembly.

5. The assembly set forth in claim 1, wherein said annular wall defines an aperture for providing access for lubricant into said housing.

6. The assembly set forth in claim 1, wherein said housing wall defines a distal end spaced from a floor disposed at an opposing end of said housing from said distal end.

7. The assembly set forth in claim 6, wherein said distal end of said housing wall defines retainer defining a groove configured to receive a snap ring for retaining said plates within said housing.

8. The assembly set forth in claim 1, wherein said housing wall defines a substantially smooth outer surface and an inner surface defining said sinusoidal configuration.

9. The assembly set forth in claim 1, wherein a work surface is defined between said wall crest and said wall trough of said housing wall with said work surface engaging said teeth of said plates.

10. The assembly set forth in claim 9, wherein said work surface defines an angle of about thirty degrees from a radial line extending from said axis defined by said housing wall.

11. The assembly set forth in claim 1, wherein said plates include a frictional material extending radially outwardly to a substantially full extent of said teeth.
